(19) United States
(12) Patent Application Publication
(10) Pub. No.: US 2010/0265510 A1
(43) Pub. Date: Oct. 21, 2010

(54) Device for recognizing and reporting fire phenomena with combustible materials

(75) Inventors: Manfred Russwurm, Bad Schwartau (DE); Bernd Ziems, Zarpen (DE); Manfred Guderjan, Bad Schwartau (DE)

Correspondence Address: COLLARD & ROE, P.C., 1077 NORTHERN BOULEVARD, ROSLYN, NY, 11576, US

(73) Assignee: Minimax GmbH & Co. KG, Bad Oldesloe (DE)

(21) Appl. No.: 12/799,187

(22) Filed: Apr. 20, 2010

(30) Foreign Application Priority Data
Apr. 21, 2009 (EP) 09005581.5

(51) Int. Cl. G01N 21/55

(52) U.S. Cl. 356/445

(57) ABSTRACT

A device for detecting and reporting fire phenomena, particularly sparks in a gas stream that might be charged with solid particles and flows through a conveyance line uses a displacement body that extends longitudinally in the flow direction of the conveyance line. The displacement body is disposed on a shaft, and a deflector is disposed at one end of the displacement body, in front of a light-permeable ring, in the interior of which a reflector is disposed. By way of an adjustable mirror at the other end in the interior of the displacement body, a signal is reflected into the interior of the shaft. The device also includes an optical reception unit and an evaluation unit at the end of the shaft.

### CROSS REFERENCE TO RELATED APPLICATIONS

Applicants claim priority under 35 U.S.C. §119 of European Application No. 09005581.5 filed Apr. 21, 2009.

### BACKGROUND OF THE INVENTION

1. Field of the Invention

The present invention relates to a device for detecting and reporting phenomena.

More particularly, the invention relates to a device for recognizing potential fire or ignition sources, particularly hot particles or sparks in transport units for combustible materials. Such devices are particularly used for monitoring the interior of pipes and channels in which combustible transport goods that consist of dusts, liquids, or solid particles are transported in a drop segment or via a conveying air stream.

The invention is suitable for use in conveyance lines, in which easily inflammable or explosive, preferably dust-form particles are pneumatically transported.

2. The Prior Art

Various possibilities are known for detecting optical fire phenomena in conveyance lines charged with solid particles and triggering an alarm. In most cases, an optical radiation on the basis of ultraviolet (UV) or infrared (IR) radiation is used. For this purpose, sensors for detecting fire are disposed either in or outside of the wall of the conveyance line, or, alternately, in a displacement body that is situated within the gas stream. These arrangements are particularly used if the speed of the gas stream and its charge of solid particles are great, so that monitoring from the pipe wall leads to incorrect results. The same holds true for pipes having a relatively great diameter.

EP 1 422 675 A1 describes a device for uncoupling dust-charged systems at risk of explosion. In this device, a sensor for detecting changes in the space at risk of explosion is disposed outside an uncoupling window, which sensor is connected with evaluation electronics and extinguishing units. For fire detection, sensors that work in the range of infrared, UV, or visible light are used.

EP 1 413 998 B1 describes a device for recognizing nests of smoldering material in a pneumatic conveyance line, in which IR sensors are disposed in an extended sleeve. The IR-permeable sleeve is disposed on a lid that can be set into the pipeline, using two attachment devices, whereby an accommodation bushing within the sleeve carries the IR sensors, whereby the accommodation bushing is composed of two parts. The displacement body has a fixed placement relative to the wall of the conveyance line, consists of a plurality of parts, and transmits the signal detected by the sensors in the interior to an alarm unit outside of the displacement body. The IR sensor or sensors are disposed in the radial direction, relative to the transport device, and protected against contamination or damage with a transparent cover. A disadvantage of this device is that the sensor or sensors are very limited in their temperature use.

A similar device as in the document EP 1 413 998 B1, for recognizing hot parts in a pneumatic conveyance line, is known from the document DE 4304890 A1. The difference is that the IR sensors are not protected against contamination or damage by a transparent cover. With this lack of protection, no permanently reliable recognition of potential fire or ignition sources is possible, because the sensors become dirty and the risk of damage caused by the conveyance stream exists.

From the document U.S. Pat. No. 3,824,392, a device for recognizing hot parts in a pneumatic conveyance line is known. In this device, a light-intensive sensor is mounted on the pipe wall with a cupola-shaped light-permeable flattened dome, to protect the sensor. A disadvantage of this device is that the flattened dome has a great tendency to become contaminated, because of its shape and because the flow velocity is low in the region of the pipe wall.

U.S. 2004/011974 A1 describes an optical reception device that measures the light scattered by the particles. In the document, an optical element that is structured to be adjustable is described in seven exemplary embodiments.

Another device for reporting optical fire phenomena, particularly sparks, is described in DE 29 16 086 B2. This device also has a displacement body within the conveyance line. This body consists of two shanks that are connected with one another in L shape and stand perpendicular to one another. The first shank is connected with the attachment means, and the other shank extends in the flow direction of the air stream and has a light entry surface at the free end. IR radiation that enters into the shank is deflected by means of fibers that guide radiation and run in arc shape, and passed to a sensor that is situated outside the pipeline. This sensor is coupled with suitable evaluation electronics, which can be used to trigger an alarm. In order to implement entry of the radiation into the one shank of the device, different solutions are proposed. In particular, conveyance streams for wood processing machines are mentioned as areas of application.

The proposed solutions have either the disadvantage that they consist of a plurality of individual parts, that the light waveguide guides the transmittable radiation to the electrical converter with great losses, that the displacement body is directed counter to the air stream but is not shaped in aerodynamic manner and thus the optics become contaminated, or that the optical window is not monitored for contamination and the alarm unit is not monitored for its ability to function.

### SUMMARY OF THE INVENTION

It is therefore an object of the present invention to provide a device for recognizing fire phenomena in conveyance lines in which solid particles are transported, which device is shaped aerodynamically, has a monitoring unit for contamination of the optics, allows reliable transmission of the data out of the material stream of the conveyance line to the outside, and demonstrates better ability to function.

These and other objects are achieved, according to the invention, by a device for detecting and reporting fire phenomena, particularly sparks in a gas stream that might be charged with solid particles and that flows through a conveyance line, by means of a displacement body that extends longitudinally in the flow direction of the conveyance line.

The device is made up of the displacement body disposed on a shaft and at least one deflector disposed at one end of the displacement body in front of a light-permeable ring, in the interior of which a reflector is disposed.

A mirror is in the interior of the displacement body, by way of which an electromagnetic radiation is reflected into the interior of the shaft. The device also includes an optical reception and evaluation unit at the end of the shaft.

The mirror is adjustable and a test emitter is provided, which emits a signal that is reflected by the light-permeable ring, whereby the reflected signal represents a measure of the degree of contamination of the light-permeable ring.

Advantageous embodiments of the invention are discussed below.

The device disposed in the conveyance line, consisting of an optical detection unit, consists of a transparent cylindrical ring, of optical reflection surfaces, adjustment units, static elements, in order to give the optical detection unit stability, optical/electrical converter, electronic evaluation unit, an optical contamination monitoring unit that can be situated within or outside the pipes and channels to be monitored, and an impact element, for example a deflector, to protect the transparent cylindrical ring from damage.

The device according to the invention disposes the displacement body, which extends along the conveyance line, on a shaft that is firmly connected with the pipe wall. At one end of the displacement body, an aerodynamically shaped deflector is disposed. This deflector is configured in terms of flow technology so that it demonstrates a low flow resistance.

It is also possible to dispose deflectors at both ends of the displacement body. This arrangement has advantages if the material stream in the conveyance line flows in different directions. The mirror should then be disposed about in the middle of the displacement body, so that it fulfills its deflection function.

Immediately behind the deflector, a light-permeable ring is disposed, in the interior of which a reflector is situated. If necessary, the ring can be coated with a special material that allows wavelength-selective detection. Attachment of the light-permeable ring can take place via a thread, preferably a metric precision thread, press fit, or gluing. A thread is advantageous for rapid assembly and interchangeability. The reflector used is structured to be rotation-symmetrical, and has a very high degree of reflection effectiveness. An adjustable mirror is disposed in the displacement body. This mirror should be disposed so that it reflects the radiation into the interior of the shaft. A spark or an ignition source within the particle stream that is conveyed with the gas stream within the pipe emits an electromagnetic or optical radiation. This radiation passes through the light-permeable ring to the reflector in the interior of the displacement body, and is reflected by it, along the shaft, to an optical reception and evaluation device at the end of the shaft, by way of the adjustable mirror.

A temperature-resistant and corrosion-resistant coating having a high degree of reflection is advantageous for the coating of reflector and mirror. Gold has proven to be particularly advantageous as a coating material, particularly because good reflection in the wavelength range being considered is achieved.

The mirror, which preferably has a concave surface, is an integral part of an adjustment insert that is easy to install and replace. Using the adjustment insert, the mirror can be adjusted by way of a rotation or pivot axis of the mirror holder, a spring, and adjustment devices, in such a manner that the electromagnetic radiation of the spark or the ignition source can be guided to the optical reception and evaluation unit at the end of the shaft, in precise and concentrated manner.

It is advantageous that the adjustment insert is disposed in the displacement body in interchangeable manner. For this purpose, there is a closure cap on the displacement body, which cap can be structured so that it can be screwed on. The reflector is configured with rotation symmetry and in conical shape. Its configuration can be conically concave or conically convex, thereby increasing or decreasing the effective visual angle. Using the concave configuration of the mirror, it is possible to guide the radiation to the optical reception and evaluation unit in bundled and concentrated manner.

Adjustment screws, setting screws, for example headless screws or cylinder pins are provided as adjustment devices for the mirror, whereby these interact with a spring, for example a helical spring. In place of this embodiment, however, a setting device with screws and counter-screws or with screws having a tensile capacity is also possible as a setting device for the mirror.

The end of the shaft leads through the pipe wall to the outside, to an evaluation unit, for example an alarm unit, in which the signal evaluation is carried out. The mirror is set in the X, Y, and Z direction, so that the electromagnetic radiation impacts the center of the optical/electrical converter at the end of the shaft. The setting device of the mirror can be represented by actuators that are disposed around the mirror. These can be piezo elements. The reception unit disposed at the end of the shaft passes the signal on to an evaluation unit, for example an alarm unit. This alarm unit can be a circuit board for evaluating the signal.

Means can be disposed on the shaft with which the shaft is adjustable in the direction toward the axis of the conveyance pipe, parallel to the pipe wall. On the other hand, the shaft can be disposed on an adapter that allows connecting the shaft firmly with the pipe wall or inserting it into the wall.

In order to check whether the light-permeable ring has become dirty, it is possible to use a test emitter, for example a transmitter diode. This device can emit a signal in the direction of the light-permeable ring to check contamination, and receive the reflected signal as a measure of the contamination. A test from the inside, however, does not lead to the result that contamination due to dark particles on the outside of the ring is perfectly recognized. For this reason, it is advantageous to carry out a test of the contamination using a test emitter from the outside, too. This emitter may be mounted on the pipe wall, for example. Both possibilities can be applied individually or in combination.

The emission of the signal can take place continuously or in a cycle, between one and ten seconds. The return signal is evaluated. As soon as it is determined that the light-permeable ring has become dirty beyond a specific degree, a related signal for cleaning or replacing the light-permeable ring can be issued by the evaluation unit.

If the adjustments are correct, the signal falls on the peak of the reflector, thereby monitoring the area of the ring all around, i.e. by 360 degrees. Monitoring takes place with a single detector. This feature is particularly advantageous as compared with tests from the outside, in which a beam enters only partially into the ring, thereby testing only the permeability at the entry surface.

It is furthermore advantageous to carry out the internal test for mirror adjustment by way of the actuators disposed on the mirror by regenerating a regulation variable from the test responses in order to adjust these actuators. In this way, it is possible to adjust the mirror optically automatically, for example in learning mode.

It is advantageous to make the light-permeable ring of glass, quartz, plastic, or sapphire. It is furthermore advantageous to configure the deflector with a smooth surface, as a steel sleeve having a rubber coating, a polytetrafluorethylene coating available under the trademark TEFLON, or a thermoplastic fluoropolymer coating available under the trademark HALAR, whereby the reflector is disposed on the opposite side and both parts can form a unit structurally. In this connection, it is advantageous to set reflector and deflector directly onto the light-permeable ring, in the form of a press fit.

It is furthermore advantageous to dispose a protective filter in front of the optical transmission and reception unit. For example, the filter may be disposed at the end of the shaft. This filter can be an optically permeable glass part, for example. Furthermore, it is advantageous if the optical signal transmitter represents a test emitter. For example, the optical signal transmitter may be a transmission diode with a light guide rod. A light rod has the advantage that specific emission characteristics are present, which facilitate mirror adjustment in the case of a point-shaped configuration. A light guide bundle can be positioned on the protective filter, in order to set off the evaluation unit, for example the alarm unit, and protect it from high temperatures. This arrangement is advantageous if the electronics can be used only for specific temperatures, for example up to 80° C., and thermal uncoupling is required.

The device according to the invention has the advantage that it consists of few parts and therefore can be produced in cost-advantageous manner. The received signals reliably reach an alarm unit or an evaluation unit, and information concerning the light-permeability of the optical window is present at all times, so that it can be replaced quickly and in uncomplicated manner.

Furthermore, it is advantageous that by means of a radiation receiver in connection with the alarm unit, an angle of 360 degrees is monitored by means of the detector, in other words only a single evaluation unit is required for all-around monitoring.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 is a fundamental representation in section of a device for detecting and reporting fire phenomena;

FIG. 2 shows the device from FIG. 1 within a conveyance line, with IR transmitter and receiver, in connection with the conveyance line; and

FIG. 3 shows a device for detecting and reporting optical fire phenomena, with monitoring device for the optical window.

### DETAILED DESCRIPTION OF PREFERRED EMBODIMENTS

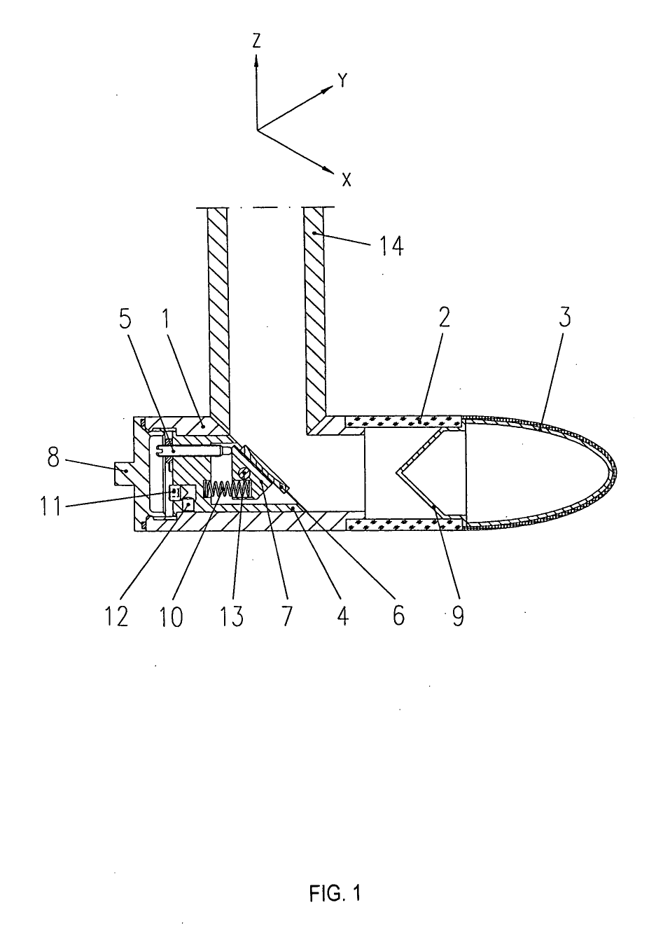

Referring now in detail to the drawings, FIG. 1 shows the device for detecting and reporting fire phenomena in a fundamental representation and in section, whereby only part of the shaft 14 is shown. The deflector 3 is connected directly with the reflector 9. Both parts are attached to the light-permeable ring 2. Light-permeable ring 2 is attached, on its other side, to the pipe of displacement body 1, by means of a screw thread. The other side of displacement body 1 is closed off via a closure cap 8, which forms a seal and is glued on in the present case. The adjustment insert 4 is introduced through closure cap 8 and attached. Adjustment insert 4 serves to adjust the concave mirror 6, which is attached to the mirror holder 7. The cylinder pin 12 and the setting screw 11, which represents a headless screw, allow adjusting mirror 6 in two directions. The pivoting movement is achieved by means of adjusting the adjustment screw 5 relative to the spring 10, whereby mirror 6 is rotated about the rotation or pivot axis 13. Therefore, after installation, a possibility exists of precise adjustment of mirror 6 in the X, Y, and Z direction. Mirror 6 and reflector 9 are provided with a gold coating that has good reflection properties and does not corrode even at higher temperatures.

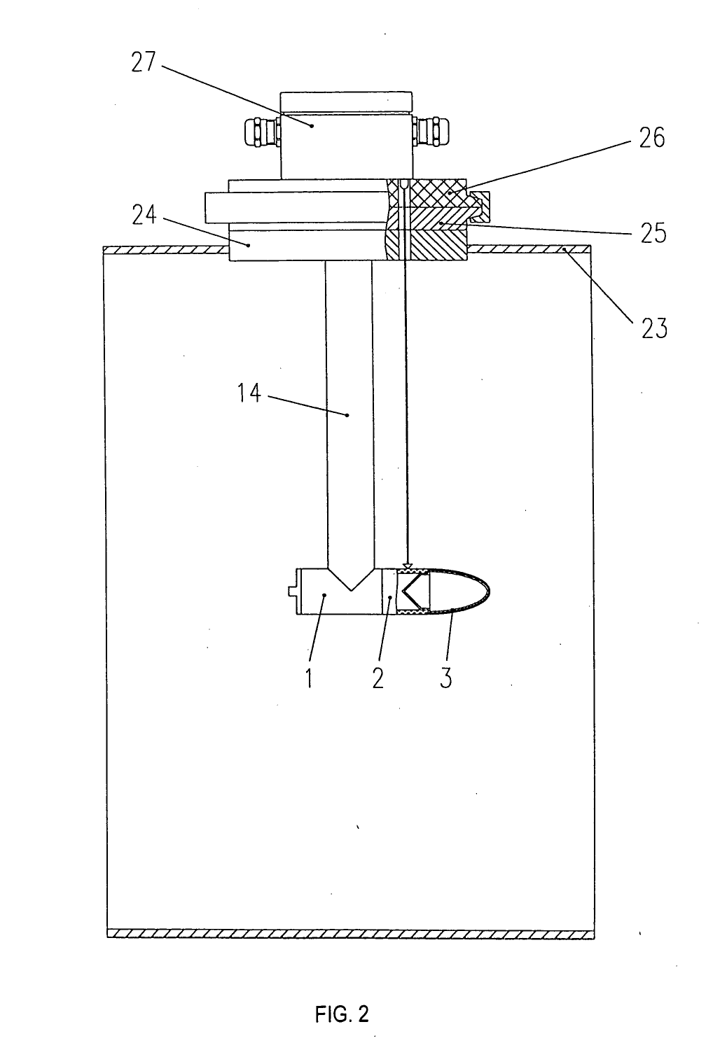

FIG. 2 shows the aforementioned device within a pipe, whereby the installation into the pipe wall 23 takes place with the insert 24 in pipe wall 23 for shaft 14, the adapter 25, and the connection to the alarm unit 26. The evaluation unit 27, an alarm unit, is disposed outside of the pipe, whereby shaft 14 leads into the pipe interior. A test emitter 18 is provided on evaluation unit 27, the signal 17 of which emitter allows checking the outside of ring 2 for contamination.

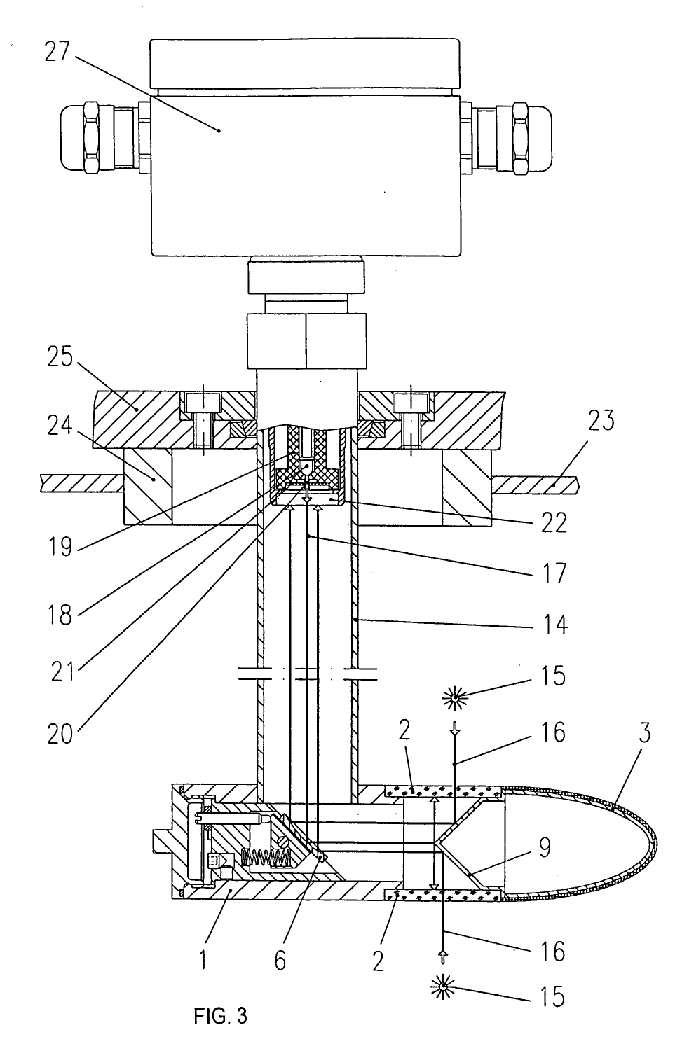

FIG. 3 shows the device for detecting and reporting spark, ignition source or other fire phenomena 15, from which electromagnetic radiation 16 proceeds, is reflected to the end of shaft 14 by reflector 9, by way of mirror 6, and gets to the transmission and reception part 19. The optical reception unit 21 converts the received signal, passes it on to evaluation unit 27, for example an alarm unit, and triggers an alarm, if necessary. A protective filler 22 may be disposed in front of optical reception unit 21.

To check the degree of contamination of light-permeable ring 2, a transmission diode is provided as a test emitter 18, which emits a base signal 17 by way of the light beam or guide rod 20. Transmission takes place at regular intervals, for example every three seconds.

This signal hits the peak of reflector 9 if mirror 6 is set correctly. The signal reflected back forms a measure of the light-permeability of ring 2. If adjustment to the peak of reflector 9 is correct, “all-around” deflection to ring 2 takes place, thereby monitoring the surface of ring 2 “all around,” by 360°. This arrangement is advantageous as compared with a test from the outside, which enters into ring 2 only partially and tests the permeability only at the entry surface. The signal received by the transmission and reception part 19 is processed by the electronics of evaluation unit 27. If a specific value is exceeded, a signal to replace ring 2 is issued.

Although only a few embodiments of the present invention have been shown and described, it is to be understood that many changes and modifications may be made thereunto without departing from the spirit and scope of the claims.

What is being claimed is:

1. A device for detecting and reporting fire phenomena in a gas stream flowing through a conveyance line comprising:
(a) a shaft having an interior portion and a shaft end;
(b) a displacement body disposed on the shaft, said displacement body having a first end;
(c) a light-permeable ring connected to the displacement body;
(d) at least one deflector disposed at the first end of the displacement body and connected to the light-permeable ring;
(e) a reflector disposed within the light-permeable ring;
(f) an adjustable mirror disposed within the displacement body for reflecting electromagnetic radiation into the interior portion of the shaft;
(g) an optical reception unit disposed within the shaft;
(h) an evaluation unit at the shaft end; and
(i) a test emitter for emitting a signal reflected by the light-permeable ring, the signal reflected by the light-permeable ring representing a degree of contamination of the light-permeable ring.

2. The device according to claim 1, further comprising an adjustment insert, the mirror being an integral part of the adjustment insert, the adjustment insert comprising a rotation or pivot axis, a mirror holder, a spring, and a plurality of adjustment devices.

3. The device according to claim 2, wherein the adjustment insert is attached to the displacement body in replaceable manner.

4. The device according to claim 2, wherein the mirror is concave and adjustable about the axis by the adjustment devices.

5. The device according to claim 1, wherein the reflector is configured to be conical, conically concave, or conically convex.

6. The device according to claim 1, further comprising an optical signal transmitter disposed at the shaft end.

7. The device according to claim 6, wherein the optical signal transmitter comprises a transmission diode having a light guide rod.

8. The device according to claim 1, further comprising a protective filter disposed in front of the optical reception unit.

9. The device according to claim 1, further comprising a plurality of shaft adjustment devices disposed on the shaft for adjusting the shaft.

10. The device according to claim 1, wherein the light-permeable ring comprises glass, quartz, plastic, or sapphire, said light-permeable ring having connection parts for screwing the light-permeable ring onto the displacement body.

11. The device according to claim 1, wherein the at least one deflector comprises a steel sleeve having first and second sides, the first side having a smooth surface, the light-permeable ring and the reflector being disposed on the second side.

12. The device according to claim 1, wherein the at least one deflector is structured with a surface that prevents adhesion.

13. The device according to claim 1, further comprising a plurality of actuators for adjustment of the mirror.

14. An assembly comprising:
(a) a conveyance line having a pipe wall; and
(b) a device for detecting and reporting fire phenomena in a gas stream flowing through the conveyance line in a flow direction, the device comprising a shaft having an interior portion and a shaft end, a displacement body disposed on the shaft and extending longitudinally in the flow direction, said displacement body having a first end, a light-permeable ring connected to the displacement body, at least one deflector disposed at the first end of the displacement body and connected to the light-permeable ring, a reflector disposed within the light-permeable ring, an adjustable mirror disposed within the displacement body for reflecting electromagnetic radiation into the interior portion of the shaft, an optical reception unit disposed within the shaft, an evaluation unit at the shaft end, and a test emitter disposed outside of or in the pipe wall for emitting a signal reflected by the light-permeable ring representing a degree of contamination of the light-permeable ring.

15. The assembly according to claim 14, wherein the test emitter is disposed on the evaluation unit.

16. The device according to claim 1, wherein the reflector and the mirror are coated with gold for reflection.
